(19) United States
(12) Patent Application Publication
(10) Pub. No.: US 2023/0418601 A1
(43) Pub. Date: Dec. 28, 2023

(54) ARITHMETIC AND CONTROL DEVICE, ARITHMETIC AND CONTROL METHOD, AND RECORDING MEDIUM

(71) Applicant: NEC Corporation, Minato-ku, Tokyo (JP)

(72) Inventor: Arihiro YOSHIDA, Tokyo (JP)

(73) Assignee: NEC Corporation, Minato-ku, Tokyo (JP)

(21) Appl. No.: 18/039,471

(22) PCT Filed: Nov. 15, 2021
(86) PCT No.: PCT/JP2021/041830

§ 371 Date: May 30, 2023

(30) Foreign Application Priority Data
Dec. 7, 2020 (JP) 2020-202595

(51) Int. Cl. G06F 9/30; G06F 9/38

(52) U.S. Cl. CPC G06F 9/3001; G06F 9/38

(57) ABSTRACT

The objective of the present invention is to shorten the processing time for calculating a specific number sequence by means of parallel arithmetic processing. A preparatory processing unit (11) uses a recurrence formula to determine arithmetic processing starting points for each of a plurality of calculators, a parallel arithmetic processing unit (12) calculates a specific number sequence by solving a given formula from the arithmetic processing starting point for each calculator, in parallel arithmetic processing employing the plurality of calculators, and a quasi-random number sequence generating unit (13) generates a quasi-random number sequence on the basis of the specific number sequence.

### TECHNICAL FIELD

The present invention relates to an arithmetic and control device, an arithmetic and control method, and a recording medium, and more particularly, to an arithmetic and control device, an arithmetic and control method, and a recording medium generating a quasi-random number sequence based on a specific sequence.

### BACKGROUND ART

Quasi-random number sequences are employed in various technical fields including computational physics. Related technologies employing the quasi-random number sequences include, for example, physical simulation, generation of computer graphics, and pricing of financial derivative products.

In related technologies, sequences (number sequences) are calculated by calculating formulae, and quasi-random number sequences are generated from the calculated sequences. Various sequences are employed to generate quasi-random number sequences. For example, NPL 1 describes a method of calculating a Sobol' sequence employing Gray codes. PTL 1 describes a method of generating a quasi-random number sequence based on a generalized Niederreiter sequence. The generalized Niederreiter sequence includes a Faure sequence in addition to the Sobol' sequence.

Furthermore, PTL 1 describes that a plurality of calculators performs calculation by sharing sequences. More specifically, in PTL 1, a section of a sequence associated with each calculator is first determined. Next, each calculator performs arithmetic processing for calculating specific sequences in parallel from a starting point of the section of the associated sequence. Accordingly, it is possible to shorten a time necessary for arithmetic processing for calculating specific number sequences.

### CITATION LIST

### Patent Literature

PTL 1: WO 1996/018144 A1

### Non Patent Literature

NPL 1: Antonov, I. A. and Saleev, V. M. (1979) “An economic method of computing LPτ-sequences”

### SUMMARY OF INVENTION

### Technical Problem

In the related technology described in PTL 1, in order to obtain an initial value serving as a starting point of a section of a sequence associated with each calculator, each calculator performs a matrix operation and a matrix vector product operation. Since a load of the matrix operation is large, the advantage that it is possible to shorten a processing time for calculating a specific sequence is impaired.

The present invention has been made in view of the above problems, and an object of the present invention is to shorten a processing time for calculating a specific sequence through parallel arithmetic processing.

### Solution to Problem

According to an aspect of the present invention, an arithmetic and control device includes preparation processing means that determines a starting point of arithmetic processing of each of a plurality of calculators by employing a recurrence relation, parallel arithmetic processing means that calculates a specific sequence by solving a given formula from a starting point of the arithmetic processing for each calculator in parallel arithmetic processing employing the plurality of calculators, and quasi-random number sequence generating means that generates a quasi-random number sequence based on the specific sequence.

According to another aspect of the present invention, an arithmetic and control method includes determining a starting point of arithmetic processing of each of a plurality of calculators by employing a recurrence relation, calculating a specific sequence by solving a given formula from a starting point of the arithmetic processing for each calculator in parallel arithmetic processing employing the plurality of calculators, and generating a quasi-random number sequence based on the specific sequence.

According to still another aspect of the present invention, a recording medium stores a program causing a computer to execute processing for determining a starting point of arithmetic processing of each of a plurality of calculators by employing a recurrence relation, processing for calculating a specific sequence by solving a given formula from a starting point of the arithmetic processing for each calculator in parallel arithmetic processing employing the plurality of calculators, and processing for generating a quasi-random number sequence based on the specific sequence.

### Advantageous Effects of Invention

According to one aspect of the present invention, it is possible to shorten a processing time for calculating a specific sequence through parallel arithmetic processing of a plurality of calculators.

### BRIEF DESCRIPTION OF DRAWINGS

FIG. 1 is a block diagram illustrating a configuration of an arithmetic and control device according to an example embodiment.

FIG. 2 is a diagram illustrating an example of preparation processing and parallel arithmetic processing according to an example embodiment.

FIG. 3 is a flowchart illustrating an operation of the arithmetic and control device according to the example embodiment.

FIG. 4 is a diagram illustrating an example of a hardware configuration of the arithmetic and control device according to an example embodiment.

FIG. 5 is a diagram illustrating an example of related technology.

### EXAMPLE EMBODIMENT

In the following description, a quasi-random number sequence includes a “low discrepancy sequence.”

(Description of Sequence)

First, a sequence employed to generate a quasi-random number sequence will be described. As a sequence employed to generate a quasi-random number sequence, a Faure sequence and a generalized Niederreiter sequence are known in addition to the Sobol' sequence described in NPL 1.

The generalized Niederreiter sequence can be expressed as in Formula 1.

xᵢ=Taᵢ(mod b)(i=0,1,2, . . . ,bⁿ−1) (Formula 1)

b is an integer of 2 or more, n is a positive integer, and T is a square matrix of order n that has an inherent integer component. In addition, aᵢ is an n-dimensional vector that has an integer component equal to or more than 0 and less than b. In Formula 1, mod b means modular arithmetic using b as a modulus. The same applies to the following formulae.

A quasi-random number sequence is obtained as xᵢ/2ⁿ (where i=0, 1, 2, . . . , bⁿ−1) from Formula 1.

Let a j-th component of the vector aᵢ be a_{i,j}. a_{i,j} is a value of a j-th digit (which is a least significant digit when j=1) in the b-adic number representation of i. a_{i,j} is defined based on Formula 2.

$$i = {\sum }_{j = 1}^{n} {a}_{i , j} {b}^{j - 1} ( 0 \leq {a}_{i , j} < b ) \qquad ( Formula 2 )$$

As shown in Formula 3, G is defined as an n-order square matrix in which all the diagonal components are 1, all the upper sub-diagonal components are −1, and all the other components are 0.

### (Formula 3)

$$G = [ \begin{matrix}1 & - 1 & & & \\ & 1 & - 1 & & \\ & & … & & \\ & & & 1 & - 1 \\ & & & & 1\end{matrix} ]$$

When expressed employing Formula 3, the above-described vector aᵢ has a property shown in Formula 4.

$${Ga}_{i + 1} = {Ga}_{i} + {e}_{{k}_{i}} ( mod b ) ( i = 0 , 1 , 2 , … , {b}^{n} - 2 ) \qquad ( Formula 4 )$$

$${e}_{j} = [ \begin{matrix}{δ}_{j 1} \\ {δ}_{j 1} \\ ⋮ \\ {δ}_{jn}\end{matrix} ]$$

δ is Kronecker delta, and kᵢ is minimum j satisfying a_{i,j}≠b−1. x′ᵢ is defined in Formula 5.

$${x}_{i}^{′} = {x}_{h} = {Ta}_{i}^{′} ( mod b ) ( i = 0 , 1 , 2 , … , {b}^{n} - 1 ) \qquad ( Formula 5 )$$

$$h = {\sum }_{j = 1}^{n} {a}_{i , j}^{′} {b}^{j - 1}$$

$$[ \begin{matrix}{a}_{i , 1}^{′} \\ {a}_{i , 2}^{′} \\ ⋮ \\ {a}_{i , n}^{′}\end{matrix} ] = {Ga}_{i} ( mod b ) ( i = 0 , 1 , 2 , … , {b}^{n} - 1 )$$

Formula 6 is obtained by applying the relational formulae shown in Formulae 4 and 5 to Formula 1.

x′ᵢ₊₁=x′ᵢ+Teₖ_{ᵢ}(mod b) (i=0,1,2, . . . ,bⁿ−2) (Formula 6)

T is a square matrix of order n that has components of n eigenvalues (where n is a positive integer). Teₖᵢ is a kᵢ-th column of the matrix T. kᵢ is a minimum j (≥1) satisfying a_{i,j}≠b−1. x′ᵢ₊₁ is calculated from the immediately preceding x′, according to Formula 6.

The quasi-random number sequence is obtained as x′ᵢ/2ⁿ (where i=1, 2, . . . , bⁿ−1) from the above Formula 5 or 6.

It is considered that a plurality of calculators perform parallel arithmetic processing in order to solve Formula 6. The parallel arithmetic processing means that a plurality of calculators shares one arithmetic processing and executes arithmetic processing in parallel. In this case, the starting point of the arithmetic processing by each calculator is first determined.

First, a related technology described in PTL 1 will be described. Formula 7 is obtained by applying the relational formulae shown in the above Formulae 5 and 6 to the above Formula 1.

x′ᵢ=TGaᵢ(mod b) (i=0,1,2, . . . ,bⁿ−1) (Formula 7)

In the related technology, each calculator determines a starting point of the arithmetic processing employing Formula 7. For example, each calculator is associated with d sequences (where d is a positive integer) in the sequences expressed by Formula 6. In this case, the first calculator calculates employing x′ᵢ as an initial value when i=0. The second and subsequent calculators calculate x′, as an initial value in each case of i=d, 2d, 3d, . . . .

Since Formula 7 includes the operation (TG) aᵢ of the matrix vector product, a load on the calculator is large. This is a disadvantage of the related technology described in PTL 1. Hereinafter, a configuration according to the example embodiment will be described.

(Arithmetic and Control Device 10)

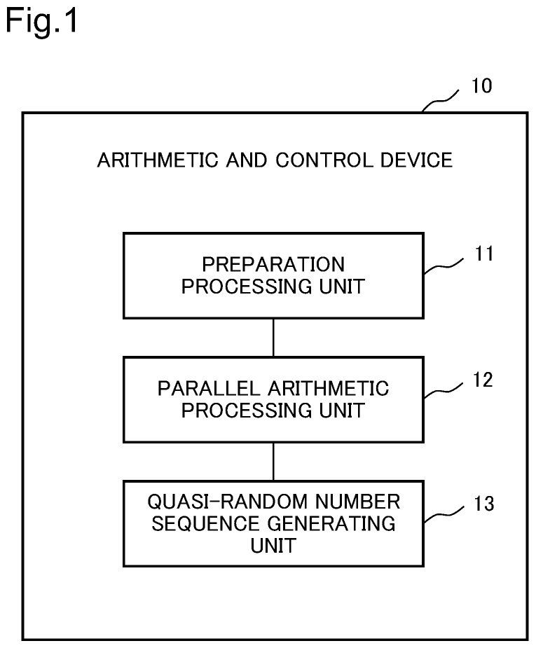

FIG. 1 is a block diagram illustrating a configuration of an arithmetic and control device 10 according to the example embodiment. As illustrated in FIG. 1, the arithmetic and control device 10 includes a preparation processing unit 11, a parallel arithmetic processing unit 12 including a plurality of calculators, and a quasi-random number sequence generating unit 13.

The preparation processing unit 11 determines a starting point of the arithmetic processing of each of the plurality of calculators employing a recurrence relation (for example, Formula 8 to be described below). Hereinafter, the processing performed by the preparation processing unit 11 is referred to as preparation processing. The preparation processing is processing for obtaining a starting point of a section of a sequence with which each of a plurality of calculators is associated. An example of the preparation processing will be described below.

The preparation processing unit 11 outputs, to the parallel arithmetic processing unit 12, information indicating the starting point of the section of the sequence with which each of the plurality of calculators is associated.

In the parallel arithmetic processing in which a plurality of calculators are employed, the parallel arithmetic processing unit 12 calculates a specific sequence by solving a given formula from a starting point of arithmetic processing for each calculator. The parallel arithmetic processing is arithmetic processing performed in parallel by the plurality of calculators. An example of the parallel arithmetic processing will be described below.

The parallel arithmetic processing unit 12 outputs the calculated data of the specific sequence to the quasi-random number sequence generating unit 13.

The quasi-random number sequence generating unit 13 generates a quasi-random number sequence based on a specific sequence. The specific sequence is a generalized Niederreiter sequence shown in Formula 1. Alternatively, the specific sequence may be a Sobol' sequence or a Faure sequence. However, the specific sequence is not particularly limited as long as the specific sequence is employed to generate the quasi-random number sequence. The data of the quasi-random number sequence may be transmitted to a subsequent stage or an external device (not illustrated) that performs arithmetic processing (for example, physical simulation) employing the quasi-random number sequence.

(Preparation Processing and Parallel Arithmetic Processing)

An example of the above-described preparation processing and parallel arithmetic processing will be supplementarily described.

It is assumed that d=b^{m} is the number d indicating the section of the sequence associated with each calculator. Here, m is a positive integer. At this time, an initial value serving as a starting point of arithmetic processing by each calculator can be calculated based on Formula 8. Formula 8 is a recurrence relation indicating a relationship between two initial values (x′ᵢ+b^{m} and x′ⁱ).

x′_{i+b}_{^{m}}=x′ᵢ+Teₘ₊ₖ_{ᵢ}−Teₘ(mod b) (i=0,1,2, . . . ,bⁿ−bₘ−1) (Formula 8)

Teₘ₊ₖᵢ and Teₘ are respectively an (m+kᵢ)-th column and an (m)-th column of the above-described matrix T. Both eₘ₊ₖᵢ and eₘ are n-dimensional vectors. In the above-described preparation processing, the preparation processing unit 11 calculates x′_{i+b}^{m} (where i=0, 1, . . . , bⁿ−b^{m}−1) as an initial value serving as a starting point of the arithmetic processing by an (i+1)-th calculator according to Formula 8.

Next, in the parallel arithmetic processing, the parallel arithmetic processing unit 12 calculates the specific sequence from the starting point obtained by the previous preparation processing according to Formula 6. Here, Formula 6 is repeated below.

x′ᵢ₊₁=+Teₖ_{ᵢ}(mod b) (i=0,1,2, . . . ,bⁿ−2) (Formula 6)

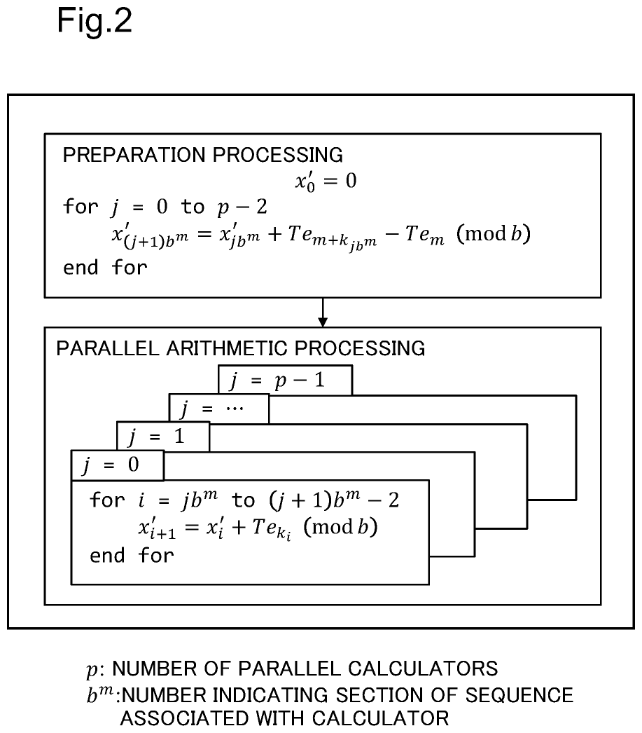

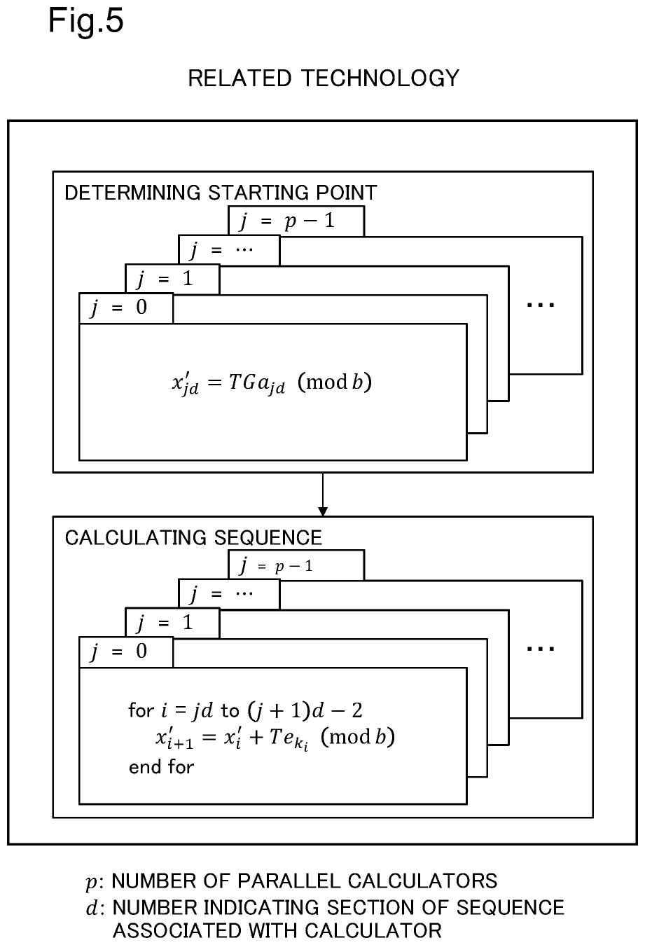

A configuration according to the example embodiment and a related technology will be described in comparison with reference to FIGS. 2 and 5. Specifically, a time required for the processing for determining the starting point of the arithmetic processing by each calculator is compared between the configuration according to the example embodiment and the related technology described in PTL 1. Here, the number of calculators performing the parallel arithmetic processing is p.

FIG. 5 illustrates a flow of the arithmetic processing in the related technology. In the related technology, the initial value serving as the starting point of the arithmetic processing by p calculators is first obtained according to Formula 7. Then, the p calculators calculate a specific sequence represented by Formula 6 from the starting point of each arithmetic processing according to Formula 6. Formula 7 includes a matrix vector product operation (TG)aᵢ. The matrix TG includes n×n components.

Accordingly, in the related technology described in PTL 1, a total number of addition or subtraction and multiplication performed to obtain the p initial values (hereinafter referred to as an arithmetic number) is p×n×(2n−1)=p(2n²−n). When the p calculators perform the parallel arithmetic processing, the time required to obtain the p initial values is p(2n²−n)÷p=(2n²−n).

FIG. 2 illustrates a flow of arithmetic processing according to the example embodiment. In the example embodiment, the initial value serving as a starting point of arithmetic processing by the p calculators is obtained through the preparation processing employing Formula 8. Thereafter, the p calculators perform parallel arithmetic processing. Formula 8 includes two vector computations between the matrix T and the n-dimensional vector. The arithmetic number for obtaining one initial value is 2×n=2n.

The total arithmetic number required for the preparation processing for obtaining the p initial values (of which the first initial value is known) is 2n×(p−1)=2n(p−1). Since Formula 8 is a recurrence relation, the p initial values are sequentially obtained one by one. The time required to obtain the p initial values is 2n(p−1).

For the time required to obtain the p initial values, the configuration according to the example embodiment is superior to that of the related technology described in PTL 1 when 2n(p−1)<2n²−n and when p<n+½.

When the sequence shown in the above Formula 6 is output as a double-precision numerical value in the international standard IEEE 754 related to floating-point arithmetic (IEEE Standard for Floating-Point Arithmetic), it is necessary to satisfy bⁿ≥2⁵³. Therefore, n≥53 log_{b}2. When the specific sequence is a Sobol' sequence, b=2, and therefore n≥53 is satisfied. That is, when p is 53 or less, the condition of p<n+½ is satisfied.

That is, when the number p of calculators is 53 or less, the configuration according to the example embodiment is superior to that of the related technology described in PTL 1. However, the conditions described here are merely examples. Under different conditions, a situation in which the configuration according to the example embodiment is superior can be different.

(Operation of Arithmetic and Control Device 10)

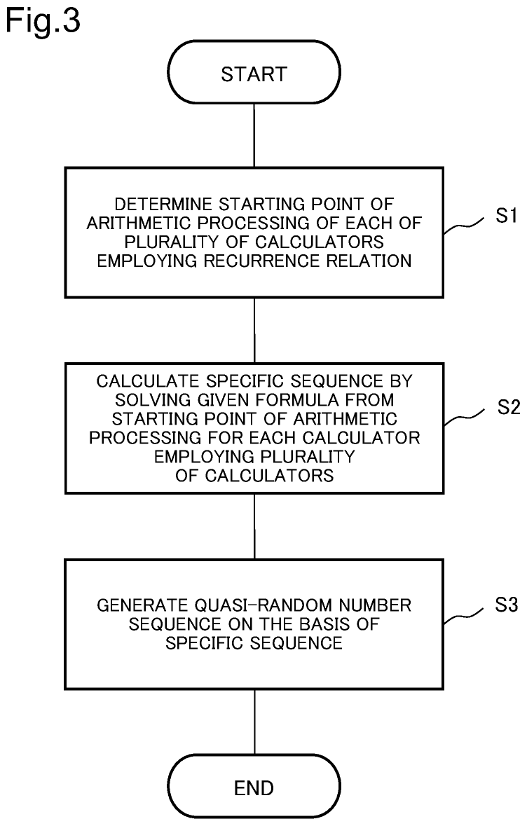

An operation of the arithmetic and control device 10 according to the example embodiment will be described with reference to FIG. 3. FIG. 3 is a flowchart illustrating a flow of processing executed by each unit of the arithmetic and control device 10.

As illustrated in FIG. 3, the preparation processing unit 11 first determines the starting point of the arithmetic processing of each of the plurality of calculators employing the recurrence relation (S1).

Subsequently, the parallel arithmetic processing unit 12 calculates a specific sequence by solving a given formula from the starting point of arithmetic processing for each calculator employing the plurality of calculators (S2).

Thereafter, the quasi-random number sequence generating unit 13 generates a quasi-random number sequence based on the specific sequence (S3).

As described above, the operation of the arithmetic and control device 10 according to the example embodiment ends.

(Effects of Present Example Embodiment) In the example embodiment, the preparation processing unit 11 determines the starting point of the arithmetic processing of each of the plurality of calculators employing the recurrence relation. The parallel arithmetic processing unit 12 calculates a specific sequence by solving the given formula from the starting point of arithmetic processing for each calculator employing a plurality of calculators. The quasi-random number sequence generating unit 13 generates a quasi-random number sequence based on a specific sequence.

As described above, according to the configuration of the example embodiment, after the starting point of the parallel arithmetic processing is first determined by the preparation processing employing the recurrence relation, the plurality of calculators perform the parallel arithmetic processing for calculating the specific sequence from each starting point. As a result, the processing time for calculating the specific sequence through the parallel arithmetic processing can be shortened as compared with the configuration in which the plurality of calculators independently calculates the starting points of the parallel arithmetic processing.

(Hardware Configuration)

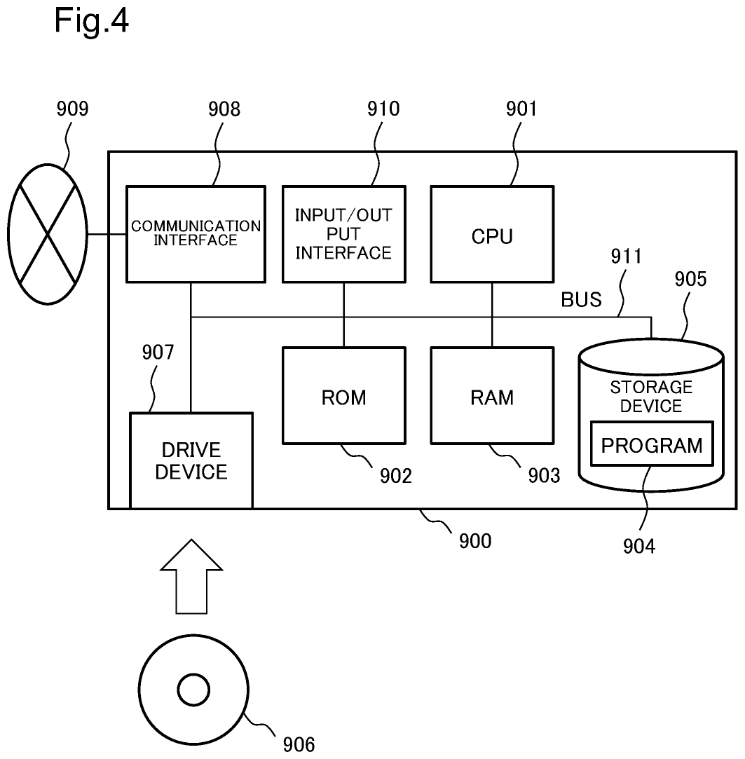

Each constituent of the arithmetic and control device 10 described in the above example embodiment indicates a block of a functional unit. Some or all of these constituents are implemented by the information processing device 900 as illustrated in FIG. 4, for example. FIG. 4 is a block diagram illustrating an example of a hardware configuration of the information processing device 900.

As illustrated in FIG. 4, the information processing device 900 includes the following configuration as an example.
CPU (Central Processing Unit) 901
ROM (Read Only Memory) 902
RAM (Random Access Memory) 903
Program 904 loaded on RAM 903
Storage device 905 storing program 904
Drive device 907 that reads and writes recording medium 906
Communication interface 908 connected to communication network 909
Input/output interface 910 for inputting/outputting data
Bus 911 connecting each constituent

Each constituent of the arithmetic and control device 10 described in the above example embodiment is implemented by the CPU 901 reading and executing the program 904 for implementing these functions. The program 904 implementing the function of each constituent is stored in advance in the storage device 905 or the ROM 902, for example, and the CPU 901 loads the program on the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the arithmetic and control device 10 described in the above example embodiment is implemented as hardware. Accordingly, it is possible to obtain advantageous effects similar to the advantageous effects described in the above example embodiment.

Although the present invention has been described with reference to the example embodiments (and examples), the present invention is not limited to the above example embodiments (and examples). Various modifications that can be understood by those skilled in the art can be made to the configurations and details of the above example embodiments (and examples) within the scope of the present invention.

This application claims priority based on Japanese Patent Application No. 2020-202595 filed on Dec. 7, 2020, the entire disclosure of which is incorporated herein.

### INDUSTRIAL APPLICABILITY

As calculation in which a quasi-random number sequence is employed, for example, there is multiple integration. The quasi-random number sequence is employed, for example, in physical operations in various scientific technologies including computational physics, generation of computer graphics, and pricing of financial derivative products.

### REFERENCE SIGNS LIST

10 Arithmetic and control device
11 Preparation processing unit
12 Parallel arithmetic processing unit
13 Quasi-random number sequence generating unit

What is claimed is:

1. An arithmetic and control device comprising:
a memory configured to store instructions; and
at least one processor configured to execute the instructions to:
determine a starting point of arithmetic processing of each of a plurality of calculators by employing a recurrence relation;
calculate a specific sequence by solving a given formula from a starting point of the arithmetic processing for each calculator in parallel arithmetic processing employing the plurality of calculators; and
generate a quasi-random number sequence based on the specific sequence.

2. The arithmetic and control device according to claim 1, wherein
the recurrence relation indicates a relationship between initial values that are starting points of each of the arithmetic processing of the plurality of calculators.

3. The arithmetic and control device according to claim 1, wherein
the specific sequence is a generalized Niederreiter sequence.

4. The arithmetic and control device according to claim 1, wherein
the quasi-random number sequence includes a hyper uniform distribution sequence, and a low discrepancy sequence.

5. An arithmetic method comprising:
determining a starting point of arithmetic processing of each of a plurality of calculators by employing a recurrence relation;
calculating a specific sequence by solving a given formula from a starting point of the arithmetic processing for each calculator in parallel arithmetic processing employing the plurality of calculators; and
generating a quasi-random number sequence based on the specific sequence.

6. A non-transitory recording medium storing a program causing a computer to execute:
processing for determining a starting point of arithmetic processing of each of a plurality of calculators by employing a recurrence relation;
processing for calculating a specific sequence by solving a given formula from a starting point of the arithmetic processing for each calculator in parallel arithmetic processing employing the plurality of calculators; and
processing for generating a quasi-random number sequence based on the specific sequence.
